(19) United States
(12) Patent Application Publication
(10) Pub. No.: US 2007/0109983 A1
(43) Pub. Date: May 17, 2007

(54) Method and System for Managing Access to a Wireless Network

(75) Inventors: Rohit Shankar, Madhapur (IN); Bharat Verma Nadimpalli, Khairatabad (IN); Muralidhar Swarangi, Visakhapatnam (IN); Srinivas Gudipudi, Nacharam (IN); Kartik Singh, Machabollaram (IN); Sumit B. Deshpande, Central Islip, NY (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 11/467,803

(22) Filed: Aug. 28, 2006

Related U.S. Application Data
(60) Provisional application No. 60/735,690, filed on Nov. 11, 2005.

(51) Int. Cl. H04B 7/00

(52) U.S. Cl. 370/310.2

(57) ABSTRACT

According to one embodiment of the invention, a method for managing access to a wireless network includes defining access criteria for a plurality of endpoint devices in the wireless network. The access criteria includes a group of access policies controlling access to specific access points in the wireless network. The group of access policies are associated with respective access points and an identifier associated with a user. The method further includes configuring at least one endpoint device of the group of endpoint devices in the wireless network with the access criteria.

### CROSS REFERENCE TO RELATED APPLICATIONS

This application claims the benefit of priority under 35 U.S.C. § 119(e) of U.S. Provisional Patent Application Ser. No. 60/735,690 entitled “Secure and Manageable Wireless Computing Systems and Methods,” which was filed on Nov. 11, 2005.

### TECHNICAL FIELD OF THE INVENTION

This invention relates generally to wireless networks, and more particularly, to a method and system for managing access to a wireless network.

### BACKGROUND OF THE INVENTION

Conventional computer networks use wires or optical fibers as the common carrier medium. However, due to improved data rates and decreasing equipment prices, businesses are rapidly adopting wireless networks as a cost effective networking solution. Using wireless network technology, businesses can easily solve end user, or client, requests and provide immediate connectivity without having to install wiring as employees move within buildings or from building to building.

The augmentation of clients wishing to communicate in various wireless network environments has caused many wireless networking systems to respond by adding elements to accommodate the increase in traffic. As wireless networks grow in size and complexity, the management and control of secure access in these wireless networks becomes more difficult.

### OVERVIEW OF EXAMPLE EMBODIMENTS

According to one embodiment of the invention, a method for managing access to a wireless network includes defining access criteria for a plurality of endpoint devices in the wireless network. The access criteria includes a group of access policies controlling access to specific access points in the wireless network. The group of access policies are associated with respective access points and an identifier associated with a user. The method further includes configuring at least one endpoint device of the group of endpoint devices in the wireless network with the access criteria.

Technical advantages of particular embodiments of the present invention include a method and system for managing access to a wireless network that accommodates limiting access to the wireless network based on criteria distributed by a managing device to endpoint devices. Thus, an administrator may control access to the wireless network from a centralized location.

Another technical advantage of particular embodiments of the present invention includes a method and system for managing access to a wireless network that automatically prevents users from connecting to malicious, unsecured, and disallowed geographic locations. Thus, in order to manage access, an administrator may configure allowed access points, disallowed access points, geographical locations, and security parameters for a user at an endpoint device.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its features and advantages, reference is now made to the following description, taken in conjunction with the accompanying drawings, in which:

FIG. 1A is a block diagram illustrating a system for managing access to a wireless network according to the teachings of the invention;

FIG. 1B is a block diagram illustrating an example access manager of the system of FIG. 1A in accordance with an embodiment of the present invention;

FIG. 2A is a block diagram illustrating example managed endpoint associations of the system of FIG. 1A, according to an embodiment of the invention;

FIG. 2B is a block diagram illustrating example managed endpoint associations of the system of FIG. 1A, according to another embodiment of the invention; and

FIG. 3 is a flow chart illustrating example acts associated with managing access to a wireless network.

### DESCRIPTION OF EXAMPLE EMBODIMENTS

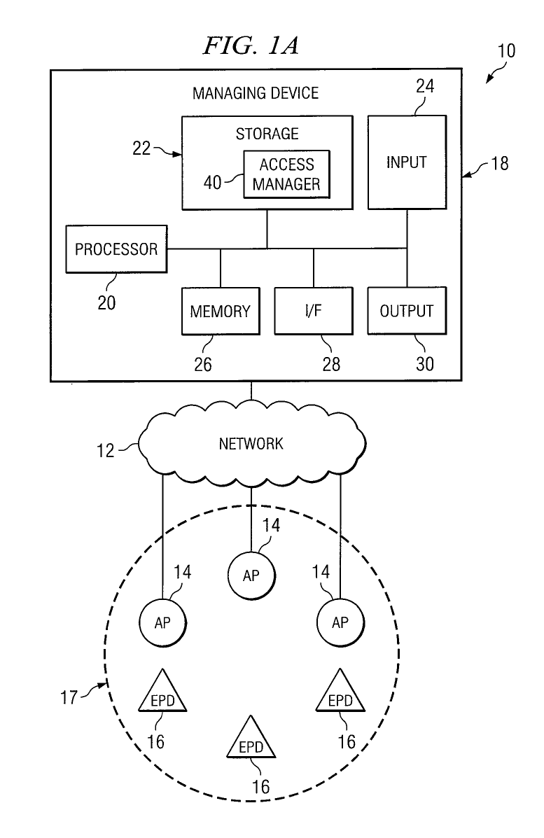

Embodiments of the present invention and its advantages are best understood by referring to FIGS. 1A through 3 of the drawings, like numerals being used for like and corresponding parts of the various drawings.

FIG. 1A is a block diagram illustrating a system 10 for managing access to a wireless network according to the teachings of the invention. As shown in FIG. 1A, system 10 generally includes a network 12, one or more access points 14, one or more endpoint devices 16, a wireless network range 17, and a managing device 18. System 10 is particularly adapted for managing access to network 12 based on access criteria for endpoint devices 16.

Network 12 may refer to any interconnecting system capable of transmitting audio, video, signals, data, messages, or any combination of the preceding. Network 12 may comprise all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

In particular embodiments of the invention, network 12 may transmit information in packet flows. A packet flow includes one or more packets sent from a source to a destination. A packet may comprise a bundle of data organized in a specific way for transmission, and a frame may comprise the payload of one or more packets organized in a specific way for transmission. A packet-based communication protocol such as Internet Protocol (IP) may be used to communicate the packet flows.

Network 12 may utilize communication protocols and technologies to transmit packet flows. Example communication protocols and technologies include those set by the Institute of Electrical and Electronics Engineers, Inc. (IEEE) standards, International Telecommunications Union (ITU-T) standards, European Telecommunications Standards Institute (ETSI) standards, Internet Engineering Task Force (IETF) standards, or other standards. As an example, network 12 may utilize the IEEE 802.xx standards such as the IEEE 802.11 standards.

Access point 14 may be any network point suitable to couple an endpoint device, such as endpoint device 16, to a network, such as network 12. Access point 14 may be, for example, a session border controller, gatekeeper, call manager, conference bridge, router, hub, switch, gateway, edge point, or any other hardware or software operable to couple an endpoint device, such as endpoint device 16, to a network.

According to one embodiment of the invention, access point 14 may have a wired connection to network 12. According to another embodiment of the invention, access point 14 may have a wireless connection to network 12. According to yet another embodiment of the invention, access point 14 may include a receiver or transmitter or both a receiver and a transmitter. As an example, access point 14 may include an omni directional antenna operable to communicate with one or more endpoint devices.

Endpoint device 16 may refer to any suitable device operable to communicate with network 12 through a access point 14. Endpoint device 16 may execute with any of the well-known MS-DOS, PC-DOS, OS-2, MAC-OS, WINDOWS™, UNIX, or other appropriate operating systems, including future operating systems. Endpoint device 16 may include, for example, a personal digital assistant, a computer such as a laptop, a cellular telephone, a mobile handset, or any other device operable to communicate with network 12 through access point 14.

Wireless network range 17 may refer to any suitable signal range for communications between access point 14 and endpoint device 16. In particular embodiments of the invention, communications between access point 14 and endpoint device 16 are communicated in wireless network range 17 according to one or more secure wireless communication protocols or WLAN protocols, such as portions or all of the Wired Equivalent Privacy (WEP) protocol, the Robust Security Network (RSN) associated with the IEEE 802.11i protocol, the IEEE 802.1x protocol, the Advanced Encryption Standard (AES), the Temporal Key Integrity Protocol (TKIP), Extensible Authentication Protocol over LAN (EAPOL) algorithms or protocols (such as EAP-TTLS, PEAP, or CISCO's LEAP or EAP-FAST protocols, for example), WiFi Protected Access (WPA) protocol, WiFi Protected Access Pre-shared key (WPA-PSK) protocol, WiFi Protected Access Version 2 (WPA2) protocol, or WiFi Protected Access Version 2 Pre-shared key (WPA2-PSK) protocol, for example.

Managing device 18 represents any device suitable to manage access for endpoint device 16 to access point 14 in a wireless network. Although FIG. 1A provides one example of managing device 18 as operating within network 12, in other embodiments managing device 18 may operate as a wireless device connecting to network 12 through a access point 14. Additional details of one example of managing device 18 are described in more detail below.

In various embodiments of the invention, a wireless network may have devices, such as access point 14 and endpoint device 16, located in various geographic areas. As the wireless network grows in size and complexity, the management and control of secure access for endpoint device 16 becomes more difficult.

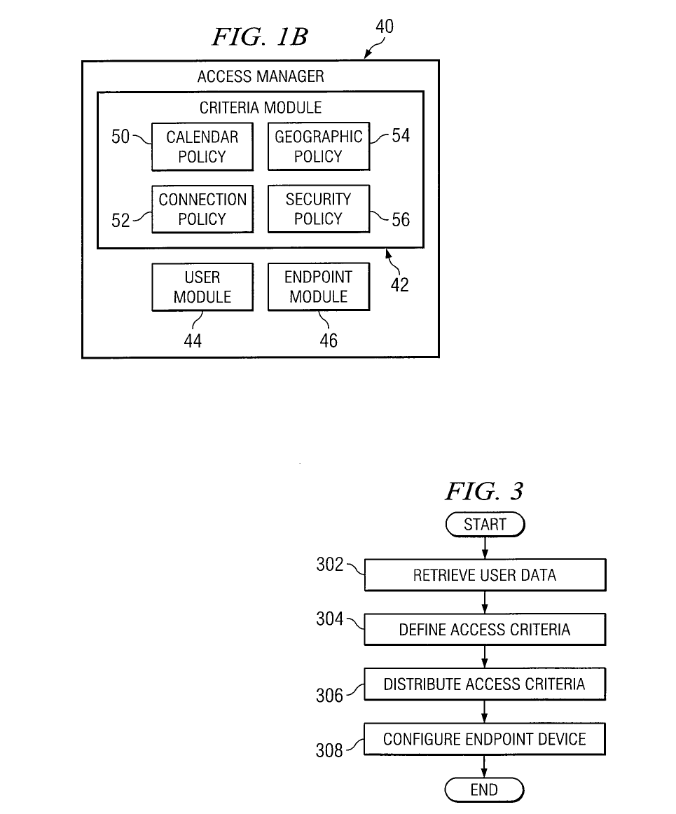

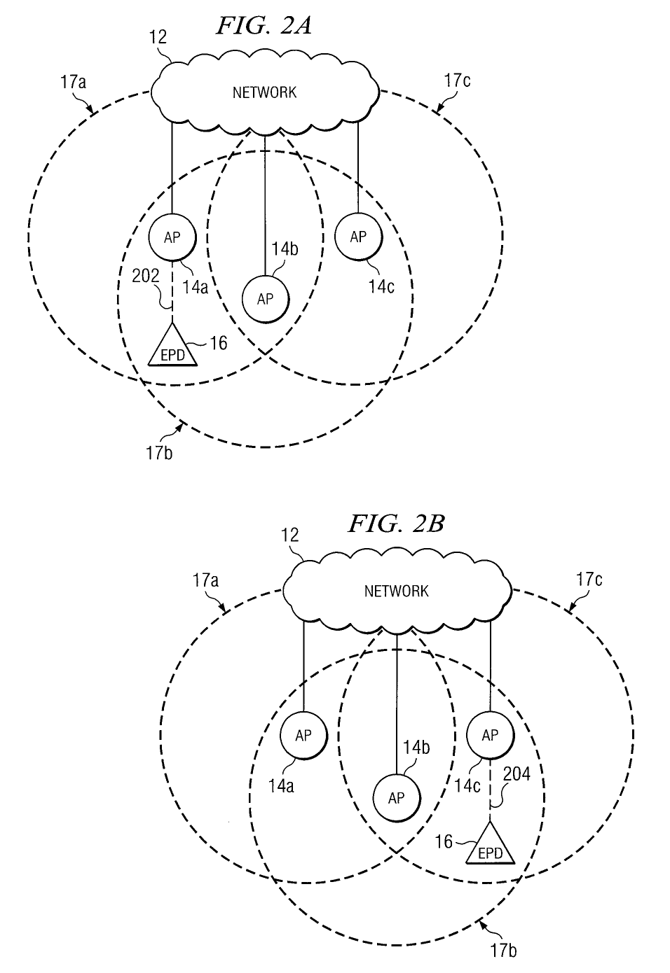

According to one embodiment of the invention, a system and method are provided that centrally manages the access for users of endpoint devices in the wireless network. This is effected by defining access criteria for the endpoint devices in the wireless network and configuring the endpoint devices with the access criteria. Additional details of example embodiments of the invention are described in greater detail below in conjunction with portions of FIG. 1A, FIG. 1B, FIG. 2A, FIG. 2B, and FIG. 3.

According to the illustrated embodiment of the invention, managing device 18 includes a processor 20, a storage device 22, an input device 24, a memory device 26, a communication interface 28, an output device 30, and an access manager 40.

Processor 20 may refer to any suitable device operable to execute instructions and manipulate data to perform operations for managing device 18. Processor 22 may include, for example, any type of central processing unit (CPU).

Storage device 22 may refer to any suitable device operable for storing data and instructions. Storage device 22 may include, for example, a magnetic disk, flash memory, or optical disk, or other suitable data storage device.

Input device 24 may refer to any suitable device operable to input, select, and/or manipulate various data and information. Input device 24 may include, for example, a keyboard, mouse, graphics tablet, joystick, light pen, microphone, scanner, or other suitable input device.

Memory device 26 may refer to any suitable device operable to store and facilitate retrieval of data, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Communication interface 28 may refer to any suitable device operable to receive input for managing device 18, send output from managing device 18, perform suitable processing of the input or output or both, communicate to other devices, or any combination of the preceding. Communication interface 28 may include appropriate hardware (e.g. modem, network interface card, etc.) and software, including protocol conversion and data processing capabilities, to communicate through a LAN, WAN, or other communication system that allows managing device 18 to communicate to other devices. Communication interface 28 may include one or more ports, conversion software, or both.

Output device 30 may refer to any suitable device operable for displaying information to a user. Output device 30 may include, for example, a video display, a printer, a plotter, or other suitable output device.

Access manager 40 may refer to any suitable logic embodied in computer-readable media, and when executed, that is operable to configure access criteria at endpoint device 16. In the illustrated embodiment of the invention, access manager 40 resides in storage device 22. In other embodiments of the invention, access manager 40 may reside in memory device 26, or any other suitable device operable to store and facilitate retrieval of data and instructions.

FIG. 1B is a block diagram illustrating an example access manager 40 of system 10 of FIG. 1A in accordance with an embodiment of the present invention. Access manager 40 may include various modules operable to perform various functions, including a criteria module 42, a user module 44, and an endpoint module 46.

According to one embodiment of the invention, criteria module 42 may define access criteria. Access criteria may refer to any rules that may be used to limit access between endpoint device 16 and access point 14. Access criteria may include access policies that control access to specific access points. In particular embodiments of the invention, when a user of endpoint device 16 attempts to connect to a particular access point 14, access policies associated with that user may contain parameters that control access rights to access point 14. For example, access point 14 may be identified by a unique identifier. If access point 14 is one of the wireless access points to which the user has access rights in the access policy, then a connection may be established. If not, a connection may be denied.

A calendar policy 50 may be defined as part of the access criteria by criteria module 42, according to one embodiment of the invention. Calendar policy 50 may refer to any policy that specifies a period of time in which a user of endpoint device 16 may connect to access point 14. For example, a calendar policy may specify that users of endpoint device 16 may connect to access point 14 during specific hours of the day.

A connection policy 52 may be defined as part of the access criteria by criteria module 42, according to one embodiment of the invention. Connection policy 52 may refer to any policy that defines valid connection types between endpoint device 16 and access point 14. The connection type may indicate whether encryption is being used, and the strength of the encryption used at endpoint device 16. For example, if encryption is not used at endpoint device 16, the connection type may be Open without 802.1x encryption enabled. As another example, if encryption is used at endpoint device 16, the connection type may be WiFi Protected Access (WPA). Thus, connections to access point 14 may be controlled based the user of endpoint device 16 and the connection type used at endpoint device 16.

A geographic policy 54 may be defined as part of the access criteria by criteria module 42, according to one embodiment of the invention. Geographic policy 54 may refer to any policy that defines geographical locations for connections between endpoint device 16 and access point 14. A geographic location may be a level of a site. A site may be a building or other physical structure. A level may be a floor, or other relative position in a site. The rules defined by the geographic policy may divide the levels of a site. For example, criteria module 42 may be used to define that users, such as software developers, should have access to specific access points 14 in a geographic location, such as the first second floors of a building. Whereas criteria module 42 may be used to define that other users, such as marketing staff, should have access to other specific access points 14 in another geographic location, such as the third floor of a building. Thus, connections to access point 14 may be controlled based on the role of a user of endpoint device 16 and the geographic location of endpoint device 16.

A security policy 56 may be defined as part of the access criteria by criteria module 42, according to one embodiment of the invention. Security policy 56 may refer to any policy that controls a variety of security parameters at endpoint device 16. For example, one security parameter may be whether network file sharing is allowed at endpoint device 16. Network file sharing may include any act of making files on one endpoint device accessible to others on a network. Another security parameter may be whether dual homing is allowed at endpoint device 16. Dual homing may include any act of connecting an endpoint device to a network in which there is a primary connection and a secondary connection. Thus, connections to access point 14 may be controlled based on the user of endpoint device 16 and the security policy enforced at endpoint device 16.

According to one embodiment of the invention, user module 44 may maintain access criteria for users of endpoint device 16. An administrator of managing device 18 may use user module 44 to maintain access criteria assigned to users of endpoint device 16. For example, when a user wishes to connect to a particular wireless access point 14, endpoint device 16 may be configured to compare an identifier associated with access point 14 to a list of access points to which the user of endpoint device 16 is permitted. It is noted that specific wireless access points to which the user is permitted may be explicitly listed, or conversely wireless access points for which the user does not have access may be explicitly listed. Other criteria may include connection type, geography, security, time period, or other suitable criteria.

According to one embodiment of the invention, user module 44 may import user data retrieved from a directory. A directory may refer to any suitable device operable to store and organize computerized content. Example directories include network operating system directories for managing logins, file-systems, and printers; security directories for single sign-on, web access management, and service management; application specific directories, such as online telephone directories, location directories, and email directories; and publishing directories, such as white pages, yellow pages, and blue pages. The importing of user data from a directory may allow user module 44 to assign access policies defined by criteria module 42 to users automatically, without manually creating data for each user.

According to one embodiment of the invention, endpoint module 46 may configure endpoint device 16 with access criteria. In one implementation, access criteria may be transmitted to endpoint device 16 by endpoint module 46. For example endpoint module 46 may transmit access criteria by transmitting software code that configures endpoint device 16 according to the instructions in the access criteria. In particular embodiments, a user may be allowed to change the access policies effected by the access criteria at endpoint device 16. In other embodiments, the user is not permitted to change the access policies.

According to one embodiment of the invention, endpoint device 16 may be configured by endpoint module 46 through an agent on endpoint device 16. An agent may be any suitable logic operable to report to endpoint module 46 upon command, and possibly on a regular basis. Endpoint module 46 may then configure access criteria at endpoint device 16 through the agent on endpoint device 16. In other embodiments, endpoint module 46 may communicate with endpoint device 16 using other protocols such as Simple Network Management Protocol (SNMP), thereby allowing third-party software agents and hardware devices to be managed.

FIG. 2A is a block diagram illustrating example managed endpoint associations of system 10 of FIGURE lA, according to an embodiment of the invention. As shown in FIG. 2A, access points 14a, 14b, and 14c are connected to a network 12. Access points 14a, 14b, and 14c may be substantially similar to access point 14 of FIG. 1A. Access points 14a, 14b, and 14c each have wireless network ranges 17a, 17b, and 17c, respectively. Wireless network ranges 17a, 17b, and 17c may be substantially similar to wireless network range 17 of FIG. 1A.

As shown in FIG. 2A, endpoint device 16 is within wireless network range 17a of access point 14a. Endpoint device 16 may attempt to connect to access point 14a, as indicated by reference number 202. According to one embodiment of the invention, access to network 12 through access point 14 for endpoint device 16 may limited based on access criteria configured at endpoint device 16. For example, access criteria may be used to define that users, such as software developers, should have access to specific access points 14 in a geographic location, whereas other users, such as marketing staff, should have access to other specific access points 14 in another geographic location. Thus, based on a geographic location and a user of endpoint device 16, connection 202 to access point 14a from endpoint device 16 may be denied.

In particular embodiments of the invention, when a user of endpoint device 16 attempts to connect to a particular access point, such as access point 14c of FIG. 2B, access policies associated with that user may contain parameters that control access rights to access point 14. For example, access point 14 may be identified by a unique identifier. If access point 14 is one of the wireless access points to which the user has access rights in the access policy, then a connection may be established as indicated by reference number 204 in FIG. 2B. Access criteria may include connection type, geography, security, time period, or other suitable criteria. Thus, as contemplated by an aspect of the present invention, secure access for users is effected through access criteria based management. Such criteria-based access prevents users from connecting to malicious, unsecured, and disallowed geographic locations.

FIG. 3 is a flow chart illustrating example acts associated with a method for managing access to a wireless network. The example acts may be performed by access manager 40, as discussed above with reference to FIG. 1A and FIG. 1B, or by other suitable device. At step 302, user data may be retrieved from a directory. A directory may refer to any suitable device operable to store and organize computerized content. Example directories include network operating system directories for managing logins, file-systems, and printers; security directories for single sign-on, web access management, and service management; application specific directories, such as online telephone directories, location directories, and email directories; and publishing directories, such as white pages, yellow pages, and blue pages. The importing of user data form a directory may accommodate assigning access policies to users automatically, without manually creating data for each user.

At step 304, access criteria may be defined for users of endpoint devices in the wireless network. Access criteria may refer to any rules that may be used to limit access between endpoint devices and access points. Access criteria may include access policies that control access to specific access points. In particular embodiments of the invention, when a user of an endpoint device attempts to connect to a particular access point, access policies associated with that user may contain parameters that control access rights to the access point. For example, an access point may be identified by a unique identifier. If the access point is one of the wireless access points to which the user has access rights in the access policy, then a connection may be established. If not, a connection may be denied. Access criteria may include connection type, geography, security, time period, or other suitable criteria.

At step 306, the defined access criteria may be distributed to the endpoint devices. For example endpoint access criteria may be distributed by transmitting software code that configures endpoint devices according to the instructions in the access criteria. In particular embodiments, a user may be allowed to change the access policies effected by the access criteria at the endpoint device. In other embodiments, the user is not permitted to change the access policies.

At step 308, endpoint devices may be configured with access criteria. Endpoint devices may be configured by agents on the endpoint devices. An agent may be any suitable logic operable to configure access criteria among endpoint devices through a customizable interface. In other embodiments, endpoint devices may be configured using other protocols such as Simple Network Management Protocol (SNMP), thereby allowing third-party software agents and hardware devices to be configured.

Thus, according to certain aspects of certain embodiments of the invention, secure access for users is managed through access criteria. Such criteria-based access prevents users from connecting to malicious, unsecured, and disallowed geographic locations. Such access criteria may be defined using a set of policies for allowed access points, disallowed access points, geographical locations, and other security parameters for a user and endpoint device.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A method for managing access to a wireless network, comprising:
defining, by a managing device, access criteria for a plurality of endpoint devices in the wireless network, the access criteria comprising a plurality of access policies controlling access to specific access points in the wireless network, the plurality of access policies associated with respective ones of the access points and an identifier associated with a user, the plurality of access policies comprising:
a calendar policy, the calendar policy specifying a period of time in which the user may access the wireless network;
a geographic location policy, the geographic policy specifying a geographic boundary in which the user may access the wireless network; and
a security policy, the security policy specifying an operational restriction on a plurality of security parameters for the plurality of endpoint devices; and
configuring, by the managing device, at least one endpoint device of the plurality of endpoint devices in the wireless network with the access criteria.

2. A method for managing access to a wireless network, comprising:
defining, by a managing device, access criteria for a plurality of endpoint devices in the wireless network, the access criteria comprising a plurality of access policies controlling access to specific access points in the wireless network, the plurality of access policies associated with respective ones of the access points and an identifier associated with a user; and
configuring, by the managing device, at least one endpoint device of the plurality of endpoint devices in the wireless network with the access criteria.

3. The method of claim 2, wherein defining, by a managing device, access criteria for a plurality of endpoint devices in the wireless network comprises defining, by the managing device, a calendar policy for the plurality of endpoint devices in the wireless network, the calendar policy specifying a period of time in which the user may access the wireless network.

4. The method of claim 2, wherein defining, by a managing device, access criteria for a plurality of endpoint devices in the wireless network comprises defining, by the managing device, a geographic policy for the plurality of endpoint devices in the wireless network, the geographic policy specifying a geographic boundary in which the user may access the wireless network.

5. The method of claim 2, wherein defining, by a managing device, access criteria for a plurality of endpoint devices in the wireless network comprises defining, by the managing device, a security policy for the plurality of endpoint devices in the wireless network, the security policy specifying an operational restriction on a plurality of security parameters for the plurality of endpoint devices.

6. The method of claim 2, wherein configuring, by the managing device, at least one endpoint device of the plurality of endpoint devices in the wireless network with the access criteria comprises transmitting, by the managing device, software code operable to configure the at least one endpoint device.

7. The method of claim 2, further comprising maintaining, by the managing device, user data for a plurality of users of the wireless network, the user data comprising access criteria for each of the plurality of users.

8. The method of claim 2, further comprising importing, by the managing device, user data for a plurality of users of the wireless network from a directory, the user data comprising access criteria for each of the plurality of users.

9. A system for managing access to a wireless network, comprising:
a plurality of access points in the wireless network; and
a managing device operable to connect to the wireless network, the managing device comprising:
a processor; and
a storage device embodying a program of instructions operable, when executed on the processor, to:
define access criteria for a plurality of endpoint devices in the wireless network, the access criteria comprising a plurality of access policies controlling access to specific wireless access points in the wireless network, the plurality of access policies associated with respective ones of the access points and an identifier associated with a user; and
configure at least one endpoint device of the plurality of endpoint devices in the wireless network with the access criteria.

10. The system of claim 9, wherein the program o f instructions is further operable to define a calendar policy for the plurality of endpoint devices in the wireless network, the calendar policy specifying a period of time in which the user may access the wireless network.

11. The system of claim 9, wherein the program of instructions is further operable to define a geographic policy for the plurality of endpoint devices in the wireless network, the geographic policy specifying a geographic boundary in which the user may access the wireless network.

12. The system of claim 9, wherein the program of instructions is further operable to define a security policy for the plurality of endpoint devices in the wireless network, the security policy specifying an operational restriction on a plurality of security parameters for the plurality of endpoint devices.

13. The system of claim 9, wherein the program of instructions is further operable to transmit software code operable to configure the at least one endpoint device.

14. The system of claim 9, wherein the program of instructions is further operable to maintain user data for a plurality of users of the wireless network, the user data comprising access criteria for each of the plurality of users.

15. The system of claim 9, wherein the program of instructions is further operable to import user data for a plurality of users of the wireless network from a directory, the user data comprising access criteria for each of the plurality of users.

16. Logic encoded in media, the logic being operable, when executed on a processor, to:
define access criteria for a plurality of endpoint devices in the wireless network, the access criteria comprising a plurality of access policies controlling access to specific access points in the wireless network, the plurality of access policies associated with respective ones of the access points and an identifier associated with a user; and
configure at least one endpoint device of the plurality of endpoint devices in the wireless network with the access criteria.

17. The logic of claim 16, wherein the logic is further operable to define a calendar policy for the plurality of endpoint devices in the wireless network, the calendar policy specifying a period of time in which the user may access the wireless network.

18. The logic of claim 16, wherein the logic is further operable to define a geographic policy for the plurality of endpoint devices in the wireless network, the geographic policy specifying a geographic boundary in which the user may access the wireless network.

19. The logic of claim 16, wherein the logic is further operable to define a security policy for the plurality of endpoint devices in the wireless network, the security policy specifying an operational restriction on a plurality of security parameters for the plurality of endpoint devices.

20. The logic of claim 16, wherein the logic is further operable to transmit software code operable to configure the at least one endpoint device.

21. The logic of claim 16, wherein the logic is further operable to maintain user data for a plurality of users of the wireless network, the user data comprising access criteria for each of the plurality of users.

22. The logic of claim 16, wherein the logic is further operable to import user data for a plurality of users of the wireless network from a directory, the user data comprising access criteria for each of the plurality of users.
